(19) United States
(12) Patent Application Publication
(10) Pub. No.: US 2014/0287348 A1
(43) Pub. Date: Sep. 25, 2014

(54) METHOD FOR MANUFACTURING A UNIT CELL OF A SOLID OXIDE FUEL CELL

(71) Applicants: Ho Sung Kim, Suwon-si (KR); Ju Hee Kang, Gwangju (KR); Ik Hyun Oh, Gwangju (KR); Duck Rye Chang, Anyang-si (KR); Jae Seong Boo, Yongin-si (KR); Chae Hwan Jeong, Gwanghu (KR); Hyo Shin Kim, Jeonju-si (KR); Eon Soo Lee, Gumi-si (KR)

(72) Inventors: Ho Sung Kim, Suwon-si (KR); Ju Hee Kang, Gwangju (KR); Ik Hyun Oh, Gwangju (KR); Duck Rye Chang, Anyang-si (KR); Jae Seong Boo, Yongin-si (KR); Chae Hwan Jeong, Gwanghu (KR); Hyo Shin Kim, Jeonju-si (KR); Eon Soo Lee, Gumi-si (KR)

(73) Assignee: Korea Institute of Industrial Technology, Cheonan-si, Chungcheongham-do (KR)

(21) Appl. No.: 14/233,853

(22) PCT Filed: Dec. 30, 2011
(86) PCT No.: PCT/KR2011/010365

§ 371 Date: May 9, 2014

(30) Foreign Application Priority Data
Jul. 20, 2011 (KR) 10 2011 0072014

(51) Int. Cl. H01M 8/12

(52) U.S. Cl. CPC H01M 8/124; H01M 2008/1293
USPC 429/535

(57) ABSTRACT

The present invention relates to a method for manufacturing unit cells of a solid oxide fuel cell through a process of attaching a fuel electrode reaction layer/electrolyte layer film assembly, manufactured using a tape casting method, onto a fuel electrode support (sintered body) which consists of the unit cells of the solid oxide fuel cell and which is manufactured using a tape casting method, a pressure method, a discharge plasma method, or the like. The method for manufacturing the unit cells of the solid oxide fuel cell comprises the steps of: forming a pre-sintered body of the fuel electrode support; manufacturing a fuel electrode reaction layer sheet; manufacturing an electrolyte layer sheet; manufacturing a film assembly by stacking, into layers, the fuel electrode reaction layer sheet and the electrolyte layer sheet; providing a binder to the pre-sintered body; combining the film assembly with the pre-sintered body provided with the binder; laminating the combined body of the pre-sintered body and the film assembly; co-sintering the laminated combined body; forming an air electrode layer on the electrolyte layer in the co-sintered body; and sintering the resultant structure.

### TECHNICAL FIELD

The present invention relates a solid oxide fuel cell (SOFC) and a method of manufacturing the SOFC, and provides technology for manufacturing a high performance and low-priced SOFC using a tape casting method.

### BACKGROUND ART

A fuel cell is defined as a cell having a capability of directly converting chemical energy of a fuel to electric energy and thereby producing the direct current (DC) electricity. As an energy conversion device of electrochemically reacting an oxidizer, for example, oxygen, and a gaseous fuel, for example, hydrogen, through an oxide electrolyte, the fuel cell may consecutively produce the electricity by supplying the fuel and the air from an outside, which differs from an existing cell.

Types of the fuel cell may include a molten carbonate fuel cell (MCFC) and a solid oxide fuel cell (SOFC) operating at a relatively high temperature, a phosphoric acid fuel cell (PAFC), an alkaline fuel cell (AFC), a proton exchange membrane fuel cell (PEMFC), a direct methanol fuel cells (DEMFC), and the like, operating at a relatively low temperature.

The SOFC refers to a system that operates at the high temperature of about 600 to 900° C. The SOFC has a high efficiency and also has very excellent characteristics in terms of economic feasibility and performance due to the diversity in a fuel selection. Also, the SOFC is configured as solid and thus, has a simple structure and has no issue resulting from loss, supplement, and corrosion of an electrode material, compared to general batteries. In addition, a noble metal catalyst is not required and hydrocarbon may be immediately used without using a reformer. Also, using a waste heat generating when discharging a high temperature gas, the thermal efficiency can be increased up to 80%. Thus, the SOFC may be used as a high performance and high efficient clean power source and may be able to achieve a thermally coupled development.

In general, a unit cell of the SOFC may be classified into a cylindrical type and a planar type based on a shape thereof, and may also be structurally classified into an anode electrode support type, a cathode electrode support type, an electrolyte support type, and the like. However, in the recent times, research on a unit cell of the anode electrode support type has been actively conducted to adjust an operating temperature of the SOFC to be an intermediate or low temperature, to enhance the durability, and to reduce costs.

The unit cell of the anode electrode support type made of an anode electrode reaction layer, for example, a functional layer, a solid electrolyte layer, and an electrode reaction layer. The unit cell of the existing anode electrode support type requires a sintering process for each of operations of forming an anode electrode support, an anode electrode reaction layer, an electrolyte layer, and a cathode electrode layer. Accordingly, a relatively large amount of time and costs are used and the quality reliability is degraded due to a high faulty occurrence rate.

That is, the related art of manufacturing a unit cell of an SOFC manufactures the unit cell using an extruding or pressurizing method. The above manufacturing process may not control the formability of a support and also accompanies a multi-staged deep coating and sintering process in order to achieve a desired thickness. Accordingly, the product reproducibility and reliability may not be maintained. Also, according to the related art, pin hole and cracks may occur in a portion in which the formability is weak. Due to a poor uniformity of a thin film, the quality issue such as a loose contact between interfaces of the unit cell may arise. Also, the unit cell of the SOFC manufactured according to the related art may have the degraded formability and have a difficulty in controlling a dimension and a microstructure for each layer according to an increase in an area of the unit cell. Accordingly, the output performance of the unit cell is degraded and the durability is also deteriorated.

### DETAILED DESCRIPTION OF THE INVENTION

### Technical Objects

Embodiments of the present invention provide a method of manufacturing a unit cell of a solid oxide fuel cell (SOFC) that may form a uniform layer regardless of different shapes and sizes of particles constituting the respective layers on a unit cell of an SOFC, and particularly, may form an electrolyte layer as a thin and dense film.

Also, embodiments of the present invention provide a method of manufacturing a unit cell of an SOFC that may easily control a thickness and microstructure of each layer on a unit cell of an SOFC.

Also, embodiments of the present invention provide a method of manufacturing a unit cell of an SOFC that may prevent cracks or peelings from occurring in an electrolyte layer during a unit cell manufacturing process.

### Technical Solutions

According to embodiments of the present invention, there is provided a method of manufacturing a unit cell of a solid oxide fuel cell (SOFC), the method including: forming a sintered body of an anode electrode support; manufacturing an anode electrode reaction layer sheet; manufacturing an electrolyte layer sheet; manufacturing a film assembly by stacking the anode electrode reaction layer sheet and the electrolyte layer sheet; providing a binder to the pre-sintered body; combining the film assembly with the pre-sintered body provided with the binder; laminating a combined body of the pre-sintered body and the film assembly; co-sintering the laminated combined body; forming a cathode electrode layer on an electrolyte layer in the co-sintered body; and sintering a resultant structure.

According to an aspect, the manufacturing of the film assembly may include manufacturing the film assembly by stacking and thereby laminating a single sheet of the anode electrode reaction layer sheet and a single sheet of the electrolyte layer sheet. Here, the anode electrode reaction layer sheet and the electrolyte layer sheet may be manufactured using a tape casting method. The anode electrode reaction layer sheet may be formed by mixing nickel oxide (NiO) and yttria stabilized zirconia (YSZ). Also, the electrolyte layer sheet may be formed using gadolinium doped ceria (GDC). Also, the film assembly may be laminated with the force of 200 kgf/cm² at the temperature of 80° C. in a state in which the anode electrode reaction layer sheet and the electrolyte layer sheet are stacked.

According to an aspect, the binder may be formed using a component capable of bonding a ceramic, and may use a terpineol based component or an ethyl cellulose based component. The providing of the binder may include applying the binder over the sintered body using a discharge plasma method or a tape casting method.

According to an aspect, the anode electrode support may be manufactured using one of a tape casting method, a pressurizing method, and a discharge plasma method.

According to an aspect, wherein the laminating may include pressuring the combined body with the force of 30 to 100 kgf/cm² at the temperature of about 50 to 100° C. Also, drying the film assembly may be performed prior to the laminating.

According to an aspect, the co-sintering may include maintaining the laminated combined body for about two to five hours at the temperature of 800 to 1200° C. and then co-sintering the laminated combined body at the temperature of 1200 to 1500° C.

### Effects of the Invention

According to embodiments of the present invention, it is possible to simplify a process of manufacturing a unit cell of a solid oxide fuel cell (SOFC) and to reduce an amount of time and costs by combining a film assembly of an anode electrode reaction layer and an electrolyte layer manufactured using a tape casting method on a porous anode electrode support, for example, a sintered body.

Also, it is possible to precisely maintain the microstructure and the dimension of the anode electrode reaction layer and the electrolyte layer.

### BRIEF DESCRIPTION OF THE DRAWINGS

FIG. 1 is a flowchart illustrating a method of manufacturing a solid oxide fuel cell (SOFC) according to an embodiment of the present invention.

FIGS. 2 through 6 are cross-sectional views illustrating the method of manufacturing an SOFC of FIG. 1.

### BEST MODE FOR CARRYING OUT THE INVENTION

Hereinafter, embodiments of the present invention are described in detail with reference to the accompanying drawings, however, the present invention is not limited thereto or restricted thereby. When describing the present invention, a detailed description related to a known function or configuration may be omitted for clarity of the description.

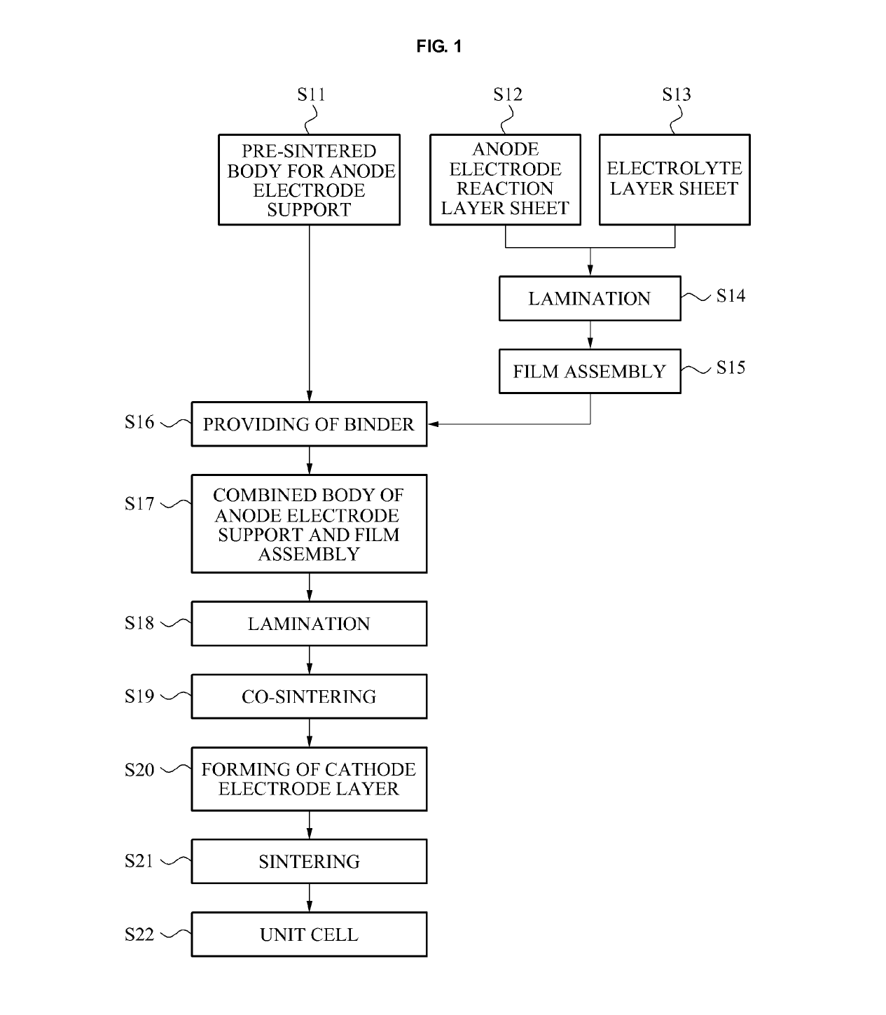

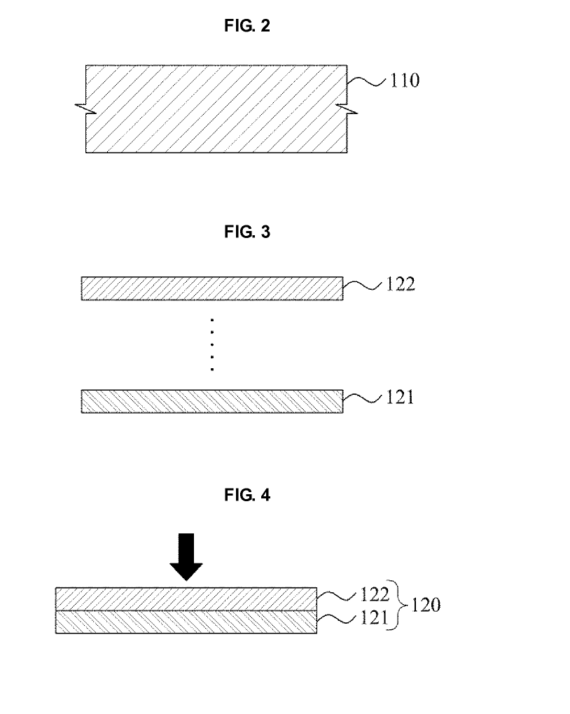

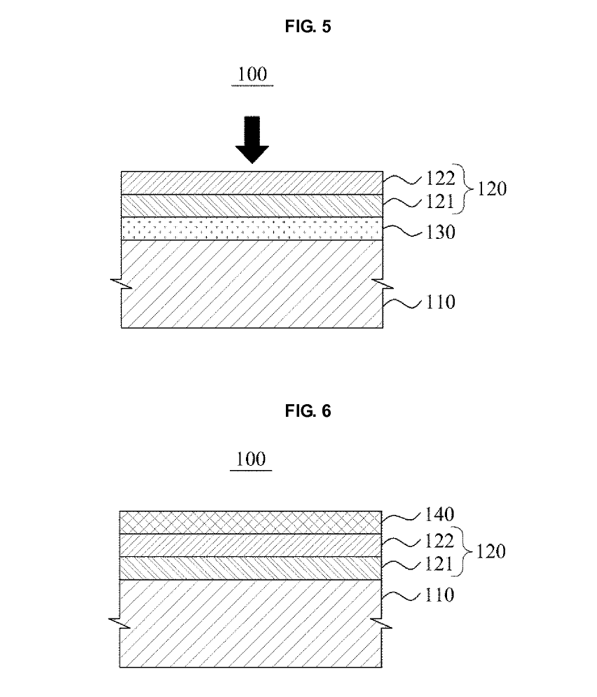

Hereinafter, a method of manufacturing a solid oxide fuel cell (SOFC) according to an embodiment of the present invention is described in detail with reference to FIGS. 1 through 6. For reference, FIG. 1 is a flowchart illustrating a method of manufacturing an SOFC according to an embodiment of the present invention, and FIGS. 2 through FIG. 6 are cross-sectional views illustrating the method of manufacturing an SOFC of FIG. 1.

Referring to the figures, in operation S11, a porous pre-sintered body for an anode electrode support 110 is manufactured.

The pre-sintered body is manufactured using one of a tape casting method, a pressurizing method, a discharge plasma method, and the like, and is formed to have a predetermined thickness. For example, the pre-sintered body is initially manufactured to have a thickness of about 1.0 mm and then is sintered at about 1350° C.

In operation S12, an anode electrode reaction layer sheet is manufactured. In operation S13, an electrolyte layer sheet is manufactured. Here, each of the anode electrode reaction layer sheet of operation S12 and the electrolyte layer sheet of operation S13 is manufactured using a tape casting method.

Specifically, in the case of the anode electrode reaction layer sheet of operation S12, a slurry is formed by mixing nickel oxide and yttria stabilized zirconia (YSZ) powders at the ratio of 60:40 or 50:50 and a green sheet (hereinafter, referred to as the “anode electrode reaction layer sheet”) with the thickness of 20 to 30 μm is manufactured using a tape casting method.

Similar to the method of manufacturing the anode electrode reaction layer sheet, in the case of the electrolyte layer sheet of operation S13, a slurry is formed using zirconia based powders or gadolinium doped ceria (GDC) powders and a green sheet (hereinafter, referred to as the “electrolyte layer sheet”) with the thickness of 10 to 20 μm is manufactured using a tape casting method.

In operation S14, a single sheet of the anode electrode reaction layer sheet and a single sheet of the electrolyte layer sheet are stacked and thereby laminated. In operation S15, a sheet-typed film assembly (hereinafter, referred to as the “film assembly”) is formed. In the film assembly, an anode electrode reaction layer and an electrolyte layer are stacked.

Here, the laminating operation may manufacture the film assembly in which the anode electrode reaction layer sheet and the electrolyte layer sheet are assembled as a single sheet by performing the lamination for ten minutes with the force of 200 kgf/cm² at 80° C. in a state in which the anode electrode reaction layer sheet and the electrolyte layer sheet are stacked.

In operation S17, the film assembly 120 is combined with the pre-sintered body of the anode electrode support 110.

In operation S16, a binder 130 is provided between the pre-sintered body of the anode electrode support 110 and the film assembly 120 in order to combine the film assembly 120 with the anode electrode support 110.

Both the pre-sintered body of the fuel electrode support 110 and the film assembly 120 are a ceramic and thus, the binder 130 is used to bond a green film assembly with a ceramic. For example, the binder 130 may use terpineol based 50 to 99 wt % or ethyl

cellulose based 1 to 50 wt %. The binder 130 may be uniformly applied over the anode electrode support 110 using a discharge plasma method and a tape casting method.

In operation S18, a lamination is performed to uniformly combine the film assembly 120 with the anode electrode support 110 after combining the film assembly 120 on the binder 130.

For example, the applied binder 130 enables the anode electrode support 110 and the film assembly 120 to bond each other by pressuring the combined body in which the film assembly 120 is combined on the anode electrode support 110 for 20 to 30 minutes with the force of 30 to 100 kgf/cm² at the temperature of about 50 to 100° C.

In operation S19, once the lamination is completed, the combined body is dried and then co-sintered.

For example, the film assembly 120 is fixed by drying the laminated combined body for 10 to 60 minutes at the temperature of 60 to 150° C.

The co-sintering is a temperature at which an organic material of the binder 130 may be removed and the binder 130 and a solvent included in the slurry for manufacturing an anode electrode reaction layer 121 and an electrolyte layer 122 may be removed. For example, the dried combined body of the anode electrode support 110 and the film assembly 120 is maintained for about two to five hours at the temperature of 800 to 1200° C. and then co-sintered at the temperature of 1200 to 1500° C.

Here, while the anode electrode support 110 has relatively large pores, the electrolyte layer has relatively small pores and requires a thin film of the dense structure. Thinning the electrolyte layer 122 decreases an ion conduction length and thus, is an essential element to improve the performance of a unit cell 100. According to the present embodiment, the electrolyte layer 122 is manufactured in a form of the film assembly 120 and thereby combined. Accordingly, it is possible to prevent cracks or peelings from occurring in the electrolyte layer 122 during a dry and sintering process. Also, the electrolyte layer 122 may not be affected by a surface flatness of the anode electrode support 110 and a thick film having an excellent flatness may be formed. Also, the electrolyte layer 122 is formed using a tape casting method and thus, the electrolyte layer 122 may be formed as a dense and thin film. A thickness and microstructure of the electrolyte layer 122 may be easily controlled.

According to the present embodiments, the film assembly 120 is co-sintered with the anode electrode support 110 and thus, the anode electrode support 110, the anode electrode reaction layer 121, and the electrolyte layer 122 may be simultaneously manufactured, thereby reducing a number of process operations and efficiently reducing manufacturing costs. Also, the anode electrode support 110 and the film assembly 120 are bonded and the manufactured unit cell 100 has an excellent interface bond-ability. In addition, thermal and mechanical characteristics of the unit cell 100 increase by significantly the decreasing interface fault between the respective layers. Accordingly, the performance of the unit cell 100 may be significantly enhanced.

In operation S20, a cathode electrode layer 140 is formed on the electrolyte layer 122 of the sintered body.

The cathode electrode layer 140 uses a screen printing method. For example, the cathode electrode layer 140 is manufactured by manufacturing a cathode electrode paste using the mixture of La0.7Sr0.3MnO3 powders and YSZ powders, and by applying the cathode electrode paste over the electrolyte layer 122. Here, the cathode electrode paste may be manufactured by mixing powders and a solvent at the ratio of 60:40 wt % and using 3-roll mil. The manufactured cathode electrode paste may constitute a multi-layer structure with the thickness of 30 to 50 μm.

In operation S21, a cathode electrode is formed by applying the cathode electrode layer 140 and then sintering the same at the temperature of 1150° C. In operation S22, the unit cell is completed.

According to the present embodiments, the unit cell 100 of the SOFC is manufactured using a method of assembling a film-typed film assembly on the pre-sintered anode support in which an anode electrode reaction layer and an electrolyte layer are stacked and thus, it is possible to effectively simplify a manufacturing process of the unit cell 100 and to effectively reduce an amount of time and costs required for manufacturing the unit cell 100. The anode electrode support 110 and the film assembly 120 are effectively bonded by the binder 130 and thus, it is possible to reduce the permeation of the solvent into the anode electrode support 110 and to uniformly bond the anode electrode support 110 and the anode electrode reaction layer 121.

Also, the unit cell 100 is manufactured by bonding the film assembly 120 manufactured in a film type. Therefore, flatness may be enhanced and the anode electrode support 110 and the electrolyte layer 122 may be uniformly formed without a locally depressed portion. As described above, according to the present embodiment, it is possible to reduce manufacturing costs and a faulty rate of a unit cell by configuring a simple and reproducible process and thus, the formability may be enhanced and a high performance SOFC may be manufactured.

Also, all of the anode electrode support 110 and the film assembly 120 are a ceramic sintered body and thus, the unit cell 100 may be manufactured through a simple process for a relatively short period of time using a method of bonding a ceramic sintered body and another ceramic body. Accordingly, there may be provided a method of efficiently manufacturing the low priced unit cell 100 in which a complex process control variable is absent.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of manufacturing a unit cell of a solid oxide fuel cell (SOFC), the method comprising:
forming a sintered body of an anode electrode support;
manufacturing an anode electrode reaction layer sheet;
manufacturing an electrolyte layer sheet;
manufacturing a film assembly by stacking the anode electrode reaction layer sheet and the electrolyte layer sheet;
providing a binder to the pre-sintered body;
combining the film assembly with the pre-sintered body provided with the binder;
laminating a combined body of the pre-sintered body and the film assembly;
co-sintering the laminated combined body;
forming a cathode electrode layer on an electrolyte layer in the co-sintered body; and
sintering a resultant structure.

2. The method of claim 1, wherein the manufacturing of the film assembly comprises manufacturing the film assembly by stacking and thereby laminating a single sheet of the anode electrode reaction layer sheet and a single sheet of the electrolyte layer sheet.

3. The method of claim 2, wherein the anode electrode reaction layer sheet and the electrolyte layer sheet are manufactured using a tape casting method.

4. The method of claim 2, wherein the anode electrode reaction layer sheet is formed by mixing nickel oxide (NiO) and yttria stabilized zirconia (YSZ).

5. The method of claim 2, wherein the electrolyte layer sheet is formed using gadolinium doped ceria (GDC).

6. The method of claim 2, wherein the film assembly is laminated with the force of 200 kgf/cm² at the temperature of 80° C. in a state in which the anode electrode reaction layer sheet and the electrolyte layer sheet are stacked.

7. The method of claim 1, wherein the binder is formed using a component capable of bonding a ceramic, and uses a terpineol based component or an ethyl cellulose based component.

8. The method of claim 7, wherein the providing of the binder comprises applying the binder over the sintered body using a discharge plasma method or a tape casting method.

9. The method of claim 1, wherein the anode electrode support is manufactured using one of a tape casting method, a pressurizing method, and a discharge plasma method.

10. The method of claim 1, wherein the laminating comprises pressuring the combined body with the force of 30 to 100 kgf/cm² at the temperature of about 50 to 100° C.

11. The method of claim 10, further comprising:
drying the film assembly prior to the laminating.

12. The method of claim 1, wherein the co-sintering comprises maintaining the laminated combined body for about two to five hours at the temperature of 800 to 1200° C. and then co-sintering the laminated combined body at the temperature of 1200 to 1500° C.
